(19) United States
(12) Patent Application Publication
(10) Pub. No.: US 2016/0225548 A1
(43) Pub. Date: Aug. 4, 2016

(54) POWER SWITCHING CONTROL APPARATUS AND CLOSING CONTROL METHOD

(71) Applicant: Mitsubishi Electric Corporation, Chiyoda-ku, Tokyo (JP)

(72) Inventors: Tomohito MORI, Tokyo (JP); Aya YAMAMOTO, Tokyo (JP); Daigo MATSUMOTO, Tokyo (JP); Takashi SHINDOI, Tokyo (JP); Shoichi KOBAYASHI, Tokyo (JP)

(73) Assignee: Mitsubishi Electric Corporation, Chiyoda-ku, Tokyo (JP)

(21) Appl. No.: 14/917,904

(22) PCT Filed: Oct. 15, 2013
(86) PCT No.: PCT/JP2013/077901

§ 371 Date: Mar. 9, 2016

(51) Int. Cl. H01H 9/54

(52) U.S. Cl. CPC H01H 9/54

(57) ABSTRACT

A power switching control apparatus includes a voltage measurement unit that measures a power-source side voltage and a transmission-line side voltage of a circuit breaker, a voltage estimation unit that estimates a power-source side voltage estimate value and a transmission-line side voltage estimate value according to measurement values, and a target closing time calculation unit that calculates a target closing time according to the estimate values. The target closing time calculation unit calculates an interpolar voltage estimate value by using both the power-source side and the transmission-line side voltage estimate value, calculates an electric turn-on time range, which is the maximum variation range of an electric turn-on time of the circuit breaker, calculates a maximum value of interpolar voltage, and determines that a time at which the maximum value of the interpolar voltage is not more than a threshold and achieves the local minimum value be a target closing time.

### FIELD

The present invention relates to a power switching control apparatus that controls the switching of a power switching apparatus and a closing control method thereof.

### BACKGROUND

In general, power switching control apparatuses need to appropriately control the timing to close a power switching apparatus, such as a circuit breaker, and inhibit transient voltage and current from occurring when the power switching apparatus is turned on.

A power switching control apparatus is described in Patent Literature 1, which controls the switching of a circuit breaker interposed between a power source and a transmission line. The apparatus determines the timing to turn on the circuit breaker by measuring a power-source side voltage and a transmission-line side voltage, multiplying the waveform of the power-source side voltage and the waveform of the transmission-line side voltage, and extracting a component of a frequency band lower than the frequency of the power source and higher than the frequency of a direct-current component from the multiplied waveform. This conventional power switching control apparatus calculates the timing to turn on a circuit breaker by using a measurement value of the transmission-line side voltage taken immediately after the current interruption on the assumption that the transmission-line side voltage does not attenuate after the current interruption.

### CITATION LIST

### Patent Literature

Patent Literature 1: Japanese Patent Application Laid-Open No. 2010-218727

### SUMMARY

### Technical Problem

In reality, however, a certain time period exists from the timing at which the circuit breaker is opened until it is turned on next, during which the transmission-line side voltage attenuates. Thus, the measurement value of the transmission-line side voltage taken immediately after the circuit breaker is opened does not coincide with the transmission-line side voltage at the time of turning on the circuit breaker after the certain time period.

For this reason, the control to close a circuit breaker at a target time calculated by using a measurement value of the transmission-line side voltage taken immediately after the current interruption, as with the conventional power switching control apparatus described above, may present a difficulty in sufficiently inhibiting an overvoltage and an overcurrent from occurring when the circuit breaker is turned on.

The present invention has been achieved in view of the above, and an object of the present invention is to provide a power switching control apparatus that is capable of estimating a variation in the transmission-line side voltage after the current interruption and thereby sufficiently inhibiting an overvoltage and an overcurrent from occurring when a circuit breaker is turned back on, and a closing control method thereof.

### Solution to Problem

In order to solve the aforementioned problems, A power switching control apparatus according to one aspect of the present invention is so constructed as to include: a voltage measurement unit that measures a power-source side voltage and a transmission-line side voltage of a circuit breaker; a voltage estimation unit that estimates a power-source side voltage estimate value on and after a present time on a basis of a measurement value of the power-source side voltage and estimates a transmission-line side voltage estimate value on and after the present time on the basis of a measurement value of the transmission-line side voltage; a target closing time calculation unit that calculates a target closing time of the circuit breaker on a basis of the power-source side voltage estimate value and the transmission-line side voltage estimate value; and a closing control unit that outputs a closing control signal to the circuit breaker on a basis of the target closing time, wherein the target closing time calculation unit includes: an interpolar voltage estimate value calculation unit that calculates an interpolar voltage estimate value by using the power-source side voltage estimate value and the transmission-line side voltage estimate value; an electric turn-on time range calculation unit that assumes, for each of times at which the interpolar voltage estimate value is calculated, that each of the times is a closing time and calculates an electric turn-on time range, which is a maximum variation range of an electric turn-on time of the circuit breaker, on the basis of the degree of variations in a closing duration of the circuit breaker and the degree of variations in a rate of decrease of dielectric strength between electrodes of the circuit breaker; an interpolar voltage maximum value calculation unit that calculates, for each of the times, a maximum value of interpolar voltage, which is a maximum value of an absolute value of the interpolar voltage estimate value in the electric turn-on time range; and a target closing time determination unit that determines that a time at which the maximum value of the interpolar voltage is not more than a threshold and achieves a local minimum value be the target closing time.

### Advantageous Effects of Invention

The present invention achieves an effect of being able to provide a power switching control apparatus capable of estimating a variation in the transmission-line side voltage after the current interruption and thereby sufficiently inhibiting an overvoltage and an overcurrent from occurring when a circuit breaker is turned back on, and a closing control method thereof.

### BRIEF DESCRIPTION OF DRAWINGS

FIG. 1 is a diagram illustrating an exemplary configuration of a power switching control apparatus according to a first embodiment.

FIG. 2 is a diagram for describing a method of calculating a transmission-line side voltage estimate value.

FIG. 3 is a diagram illustrating an exemplary configuration of an environmental condition measurement unit.

FIG. 4 is a diagram illustrating an exemplary functional configuration of a target closing time calculation unit.

FIG. 5 is a diagram for describing a turn-on time of a circuit breaker.

FIG. 6 is a diagram for describing a closing time range and an electric turn-on time range.

FIG. 7 is another diagram for describing the closing time range and the electric turn-on time range.

FIG. 8 is a diagram illustrating an example waveform of maximum values of the interpolar voltage.

FIG. 9 is a diagram for describing example setting of a target closing time.

FIG. 10 is a diagram illustrating a turn-on flag of each phase.

FIG. 11 is a flowchart illustrating a closing control method according to the first embodiment.

FIG. 12 is a flowchart illustrating a calculation process of an eigenvalue λᵢ and a residual matrix [B].

### DESCRIPTION OF EMBODIMENTS

Exemplary embodiments of a power switching control apparatus according to the present invention and a closing control method thereof will now be described in detail with reference to the drawings. The present invention is not limited to the embodiments.

### First Embodiment

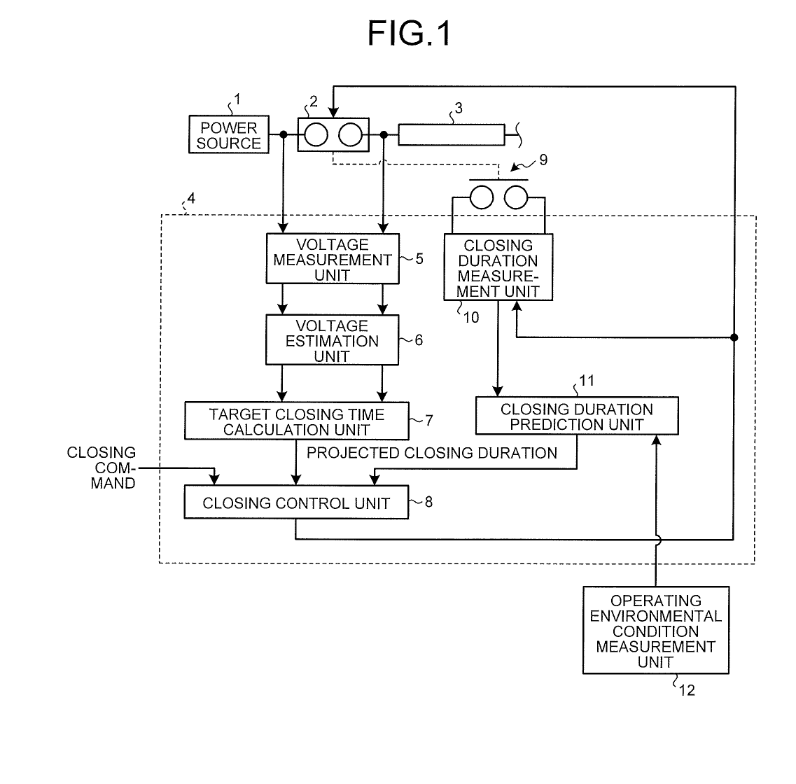

FIG. 1 is a diagram illustrating an exemplary configuration of a power switching control apparatus according to the present embodiment. As illustrated in FIG.

1, a circuit breaker 2 is connected between a power source 1 and a transmission line 3, and a power switching control apparatus 4 is connected to the circuit breaker 2.

The power source 1 is a three-phase AC power source. The circuit breaker 2 is, for example, a gas circuit breaker. The transmission line 3 is a transmission line with shunt reactor compensation or a transmission line with no shunt reactor compensation. Here, a transmission line with the shunt reactor compensation refers to a transmission line provided with a shunt reactor (not illustrated) on the transmission line side (load side) of the circuit breaker 2. A transmission line with no shunt reactor compensation refers to a transmission line provided with no shunt reactor on the transmission line side of the circuit breaker 2. In the case of the transmission line 3 being a transmission line with the shunt reactor compensation, an AC voltage of a certain frequency occurs on the transmission line side of the circuit breaker 2 after the opening of the circuit breaker 2 due to the shunt reactor and the electrostatic capacitance of the transmission line 3. In the case of the transmission line 3 being a transmission line with no shunt reactor compensation, a DC voltage corresponding to the power-source side voltage at the time of the interruption is generated on the transmission line side of the circuit breaker 2 after the opening of the circuit breaker 2. Note that the configuration illustrated in FIG. 1 is for only one of the three phases, with those for the other two phases being omitted.

The power switching control apparatus 4 includes a voltage measurement unit 5, which is connected to both the power source side and the transmission line side, a voltage estimation unit 6, which is connected to the voltage measurement unit 5, a target closing time calculation unit 7, which is connected to the voltage estimation unit 6, a closing control unit 8, which is connected to the target closing time calculation unit 7, a closing duration measurement unit 10, which is connected to an auxiliary switch 9 linked with the circuit breaker 2 and to the closing control unit 8, and a closing duration prediction unit 11, which is connected to the closing duration measurement unit 10 and the closing control unit 8. The closing duration prediction unit 11 is connected to an operating environmental condition measurement unit 12, which is, for example, provided outside the power switching control apparatus 4.

The voltage measurement unit 5 measures the power-source side voltage and the transmission-line side voltage of the circuit breaker 2 in, for example, a certain cycle. The voltage measurement unit 5 also outputs measurement values of the power-source side voltage and the transmission-line side voltage to the voltage estimation unit 6. The voltage measurement unit 5 outputs the measurement values of the power-source side voltage and the transmission-line side voltage to the voltage estimation unit 6 every time the measurement is performed.

The voltage estimation unit 6 estimates power-source side voltage estimate values on and after the present time on the basis of measurement values of the power-source side voltage output by the voltage measurement unit 5 for, for example, a past certain duration and estimates transmission-line side voltage estimate values on and after the present time on the basis of measurement values of the transmission-line side voltage output by the voltage measurement unit 5 for, for example, a past certain duration. The voltage estimation unit 6 outputs a power-source side voltage estimate value and a transmission-line side voltage estimate value to the target closing time calculation unit 7.

An exemplary method of calculating a power-source side voltage estimate value and a transmission-line side voltage estimate value by the voltage estimation unit 6 will be described below.

Firstly, a method of calculating a transmission-line side voltage estimate value will now be described. Because the transmission-line side voltage after the interruption of the circuit breaker 2 generally achieves a multi-frequency composite waveform, a transmission-line side voltage estimate value at a time t can be expressed in an expression below in general, where Aᵢ represents an amplitude, σᵢ(<0) represents an attenuation factor, fᵢ represents a frequency, and φᵢ represents a phase, as waveform parameters.

$$\begin{matrix}[ Expression 1 ] & \\ y ( t ) = {\sum }_{i = 1}^{M} {A}_{i} exp ( {σ}_{i} t ) cos ( 2 π {f}_{i} t + {φ}_{i} ) & ( 1 )\end{matrix}$$

Here, M represents the number of components of the composite waveform, with i being an integer value from 1 to M. M is preset with consideration given to computational precision and the like.

The total number of the waveform parameters in the expression (1) described above is (4×M); by determining all these waveform parameters using a measurement value of the transmission-line side voltage, a transmission-line side voltage estimate value at any arbitrary time t can be obtained.

The voltage estimation unit 6 determines all the waveform parameters in the expression (1) described above by, for example, a method of least squares using n (≧4×M) pieces of measurement values of the transmission-line side voltage output from the voltage measurement unit 5. Here, n pieces of measurement values of the transmission-line side voltage represent measurement values in, for example, a past certain duration.

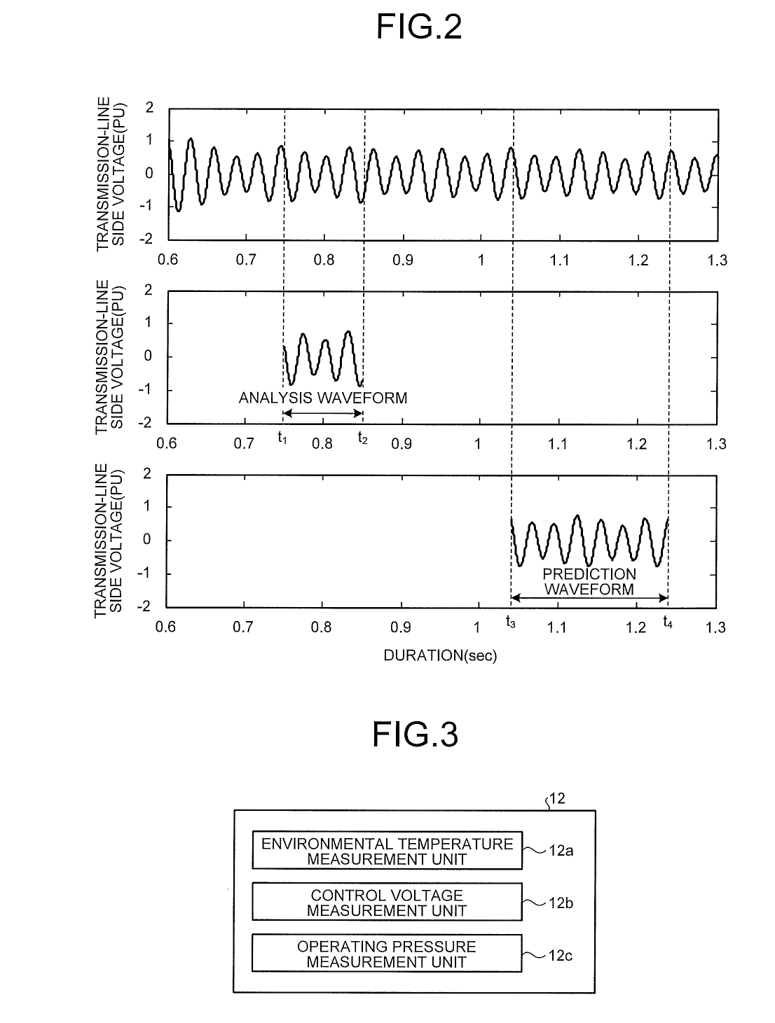

FIG. 2 is a diagram for describing a method of calculating a transmission-line side voltage estimate value. The upper part of the diagram illustrates a measurement waveform of the transmission-line side voltage, indicating measurement values of the transmission-line side voltage chronologically with the horizontal axis representing the duration (sec) and the vertical axis representing the transmission-line side voltage (PU). The voltage is expressed in values normalized with rated voltage values (PU). The middle part of the diagram illustrates an analysis waveform to be used for the estimation of the transmission-line side voltage. Specifically, a part of the measurement waveform for, for example, a certain duration in the past (the duration from a time t₁ to a time t₂) from the present time being t₃ is acquired as an analysis waveform. The waveform parameters in the expression (1) described above are then determined by using measurement values at n pieces of discrete points included in the analysis waveform. The lower part of the diagram illustrates a prediction waveform. Specifically, this is a waveform of transmission-line side voltage estimate values on and after the present time t₃ from, for example, the time t₃ to a time t₄ obtained according to the expression (1).

Instead of obtaining an analysis waveform in the manner described by the middle part of FIG. 2, measurement values for an immediate past certain duration from the present time t₃ may be used. That is, the part of the measurement waveform from the time t₃−Δt to the time t₃ may be selected as an analysis waveform. Here, the Δt is a preset past certain duration.

The voltage estimation unit 6 may update a transmission-line side voltage estimate value by using the latest voltage measurement value. For example, after transmission-line side voltage estimate values on and after the present time t₃ are obtained at the present time t₃ by using voltage measurement values in an immediate past certain duration Δt and then the present time has become t₃+Δt, transmission-line side voltage estimate values on and after the present time t₃+Δt may be obtained again by using voltage measurement values in the immediate past certain duration Δt.

Secondly, a method of calculating a power-source side voltage estimate value will now be described. A power-source side voltage estimate value can be also estimated by applying, for example, the method of least squares to the expression (1) described above, as with a transmission-line side voltage estimate value. Note, however, that the power-source side voltage has a single frequency (M=1), that the frequency of the power-source side voltage is a stationary frequency (for example, 50 Hz or 60 Hz), that a voltage amplitude value is known, and that its attenuation factor is zero; thus, by giving these pieces of known information as initial setting information to the voltage estimation unit 6 in advance, the waveform parameters can be determined without using the method of least squares. For the phase, for example, a zero point at which values change from the negative to the positive may be obtained from measurement values to determine φ in such a manner that (2π×f×t+φ)=π/2 at a time on the zero point.

The target closing time calculation unit 7 calculates a target closing time for the circuit breaker 2 on the basis of power-source side voltage estimate values and transmission-line side voltage estimate values output from the voltage estimation unit 6. The calculation process of the target closing time will be described in detail hereinafter.

On receipt of a closing command, the closing control unit 8 outputs a closing control signal at a time before the target closing time by a predicted closing duration.

Here, the predicted closing duration refers to a predicted value of a closing duration from when a closing control signal is output to the circuit breaker 2 until when a movable contact (not illustrated) of the circuit breaker 2 comes in mechanical contact with a fixed contact (not illustrated) thereof. The closing duration of the circuit breaker 2 varies depending on an operating environmental condition, such as environmental temperature, control voltage, and operating pressure; it also varies with the state change of an individual circuit breaker, such as contact wear, chronological change, and small individual differences. Of the variations in the closing duration of the circuit breaker 2, a correction common to the same type of circuit breakers can be used for those depending on the operating environmental condition. Of the variations in the closing duration of the circuit breaker 2, individual corrections are needed for those depending on the state change of the circuit breaker 2. Hence, the predicted closing duration can be corrected by a first correction duration corresponding to an operating environmental condition, such as environmental temperature, control voltage, and operating pressure, and by a second correction duration based on past operation history.

Specifically, a reference closing duration, which is an average value of closing durations under certain conditions of the environmental temperature, the control voltage, and the operating pressure, is measured in advance.

Another average value of closing durations is also measured in advance with the closing achieved under an environmental temperature, a control voltage, and an operating pressure varied from the certain operating environmental conditions described above. A difference value is then calculated between this average value of closing durations and the reference closing duration, and a table that associates the operating environmental conditions with the difference value is created.

When in operation, a first correction duration corresponding to actual operating environmental conditions is calculated by referencing the table described above on the basis of the actual operating environmental conditions (the environmental temperature, the control voltage, and the operating pressure) and performing interpolation or the like in accordance with the difference between the operating environmental conditions in the table and the actual environmental conditions.

Additionally, errors between past actual closing durations and predicted closing durations obtained at the time of these operations are obtained by n times in the past (for example, 10 times in the past) to calculate a second correction duration based on the past operation history with the errors, for example, weighted. Here, the weighting is set such that it is greater for an error occurred at a point in time closer to that of the operation, or in like manner.

Using the calculated values described above can achieve predicted closing duration=reference closing duration+first correction duration+second correction duration.

The closing duration measurement unit 10 measures an actual closing duration by calculating the difference between an output time of a closing control signal from the closing control unit 8 and an operation time of the auxiliary switch 9 linked with the movable contact of the circuit breaker 2. The closing duration measurement unit 10 outputs the measurement value of the closing duration to the closing duration prediction unit 11.

FIG. 3 is a diagram illustrating an exemplary configuration of the operating environmental condition measurement unit 12. The operating environmental condition measurement unit 12 includes, for example, an environmental temperature measurement unit 12a, a control voltage measurement unit 12b, and an operating pressure measurement unit 12c. The environmental temperature measurement unit 12a measures an environmental temperature and outputs the measurement value to the closing duration prediction unit 11. The control voltage measurement unit 12b measures a control voltage at the time of activating the circuit breaker 2 and outputs the measurement value to the closing duration prediction unit 11. The operating pressure measurement unit 12c measures an operating pressure (for example, hydraulic pressure) at the time of the activating the circuit breaker 2 and outputs the measurement value to the closing duration prediction unit 11.

The closing duration prediction unit 11 includes the reference closing duration information and the table information described above. Additionally, the closing duration prediction unit 11 has stored past actual closing durations and predicted closing durations obtained at the time of these operations. The closing duration prediction unit 11 then refers to the table information described above on the basis of an environmental temperature output from the operating environmental temperature measurement unit 12a, a control voltage output from the control voltage measurement unit 12b, and an operating pressure output from the operating pressure measurement unit 12c to calculate a first correction duration corresponding to the environmental conditions, obtains, for example, weighted average of errors between past closing durations and predicted closing durations at the time of these operations to calculate a second correction duration, and calculates a predicted closing duration, which is the sum of the reference closing duration, the first correction duration, and the second correction duration.

A method of calculating a target closing time by the target closing time calculation unit 7 will now be described. The target closing time is a target time at which the circuit breaker 2 is turned on mechanically, and it is a time at which the movable contact (not illustrated) of the circuit breaker 2 comes in contact with the fixed contact (not illustrated).

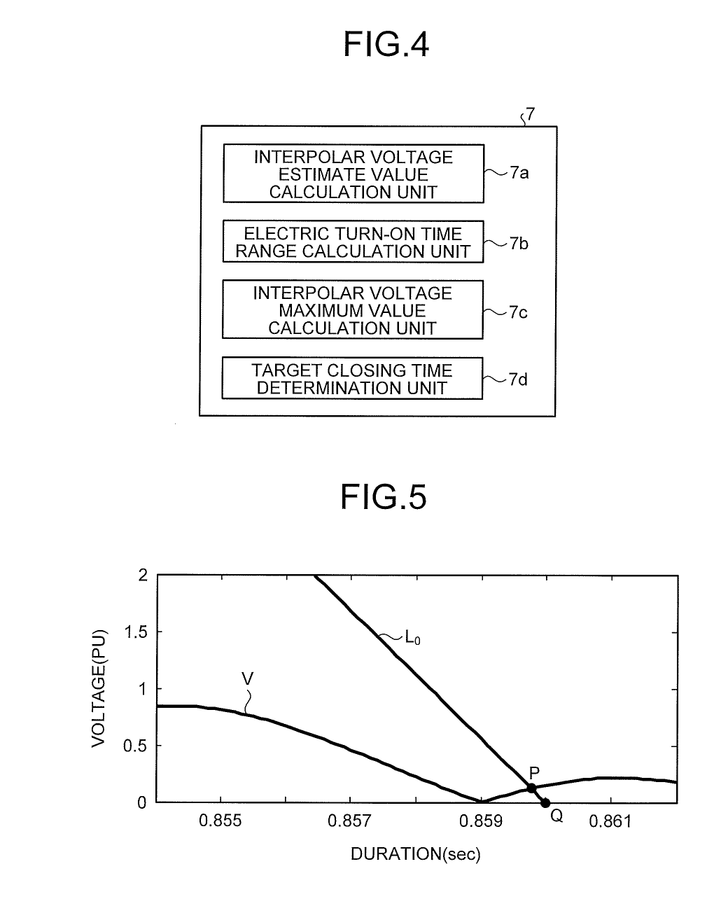

FIG. 4 is a diagram illustrating an exemplary functional configuration of the target closing time calculation unit 7. As illustrated in FIG. 4, the target closing time calculation unit 7 includes an interpolar voltage estimate value calculation unit 7a, an electric turn-on time range calculation unit 7b, an interpolar voltage maximum value calculation unit 7c, and a target closing time determination unit 7d. The interpolar voltage estimate value calculation unit 7a calculates an estimate value of the interpolar voltage, which is the difference between a power-source side voltage estimate value and a transmission-line side voltage estimate value, and then calculates the absolute value of the estimate value of the interpolar voltage.

During the closing process of the circuit breaker 2, the dielectric strength between electrodes decreases as the distance between electrodes decreases. At a point in time when the dielectric strength decreases to or below the electric field value due to the voltage applied between electrodes, a preceding arc, which accompanies a dielectric breakdown between electrodes, occurs to turn on the circuit breaker 2 electrically. That is, the circuit breaker 2 is electrically turned on at a point of intersection between an absolute value waveform of the interpolar voltage of the circuit breaker 2 and a dielectric strength change rate characteristic line representing the rate of decrease of dielectric strength (RDDS) between electrodes during the closing process of the circuit breaker 2. This will be described in detail with reference to FIG. 5.

FIG. 5 is a diagram for describing a turn-on time of the circuit breaker 2. The horizontal axis represent the duration (sec); the vertical axis represents the voltage (PU). An absolute value waveform of the interpolar voltage is designated with V. A dielectric strength change rate characteristic line is designated with L₀. As described above, the time at the point of intersection P between V and L₀ is the time at which the circuit breaker 2 is turned on electrically. The time at the point of intersection Q between L₀ and the horizontal axis (voltage=0) is the time at which the circuit breaker 2 is turned on mechanically. In other words, the point of intersection Q is a closing point. The line L₀ is a dielectric strength change rate characteristic line having the closing time at the time on the closing point Q.

In contrast, a target closing time needs to be set such that an overvoltage and an overcurrent are inhibited from occurring at the time of turning on electrically. Because an overvoltage and an overcurrent are inhibited to a greater degree when the absolute value of the interpolar voltage at the time of turning on electrically is smaller, a target closing time needs to be set such that the absolute value of the interpolar voltage at the time of turning on electrically is not more than a preset threshold Y. Here, the threshold Y is given such a value that an overvoltage and an overcurrent are within permissible ranges when the absolute value of the interpolar voltage at the time of turning on electrically is not more than this value.

It should be noted, however, that, because the operation duration of the circuit breaker 2 involves variations and the rate of decrease of dielectric strength between electrodes involves probabilistic variations, obtaining, with respect to a given closing point, an electric turn-on time from a point of intersection between a single dielectric strength change rate characteristic line passing through this closing point and an absolute value waveform of the interpolar voltage estimate values and evaluating an absolute value of the interpolar voltage estimate value at this time is insufficient.

More specifically, since the operation duration (the closing duration in this case) of the circuit breaker 2 involves variations, an actual closing time may be shifted from the time on the point of intersection Q in FIG. 5; this may shift the time of the point of intersection P accordingly, shifting also the absolute value of the interpolar voltage at the time of turning on electrically from the initially estimated value.

Furthermore, a dielectric breakdown is a probabilistic event, and thus, the gradient of a dielectric strength change rate characteristic line may vary around its average value. This variation in the gradient also leads to variation in the time on the point of intersection P. Note that the absolute value of the gradient of a dielectric strength change rate characteristic line is equal to the rate of decrease of dielectric strength between electrodes.

Hence, the present embodiment evaluates in advance a closing time deviation width ΔT, which indicates the degree of variations in the operation duration of the circuit breaker 2, and evaluates in advance a rate of decrease of dielectric strength deviation width Δk, which indicates the degree of probabilistic variations in the rate of decrease of dielectric strength between electrodes, to provide information on ΔT and Δk to the target closing time calculation unit 7.

In other words, the variation range of the closing time with respect to a closing time t( )can be evaluated to determine that it is from (t_{Q}−ΔT) to (t_{Q}+ΔT). Here, ΔT can be obtained from measurement values from the measurement performed more than once of the closing duration of the circuit breaker 2. Specifically, a standard deviation can be obtained by using measurement values of the closing duration measured more than once at points in time close to that of the operation to determine that ΔT is, for example, triple the standard deviation. Alternatively, ΔT may be determined from the result of operation measurement at the time of equipment installation or from past operation history recorded in the device. The variation range of the rate of decrease of dielectric strength k between electrodes can be evaluated to determine that it is from (k−Δk) to (k+Δk). Here, Δk can be, for example, triple the standard deviation of k. Note that the variation range of k, which is a range from ((k−Δk) to (k+Δk)) is hereinafter referred to as a “range of the rate of decrease of dielectric strength”.

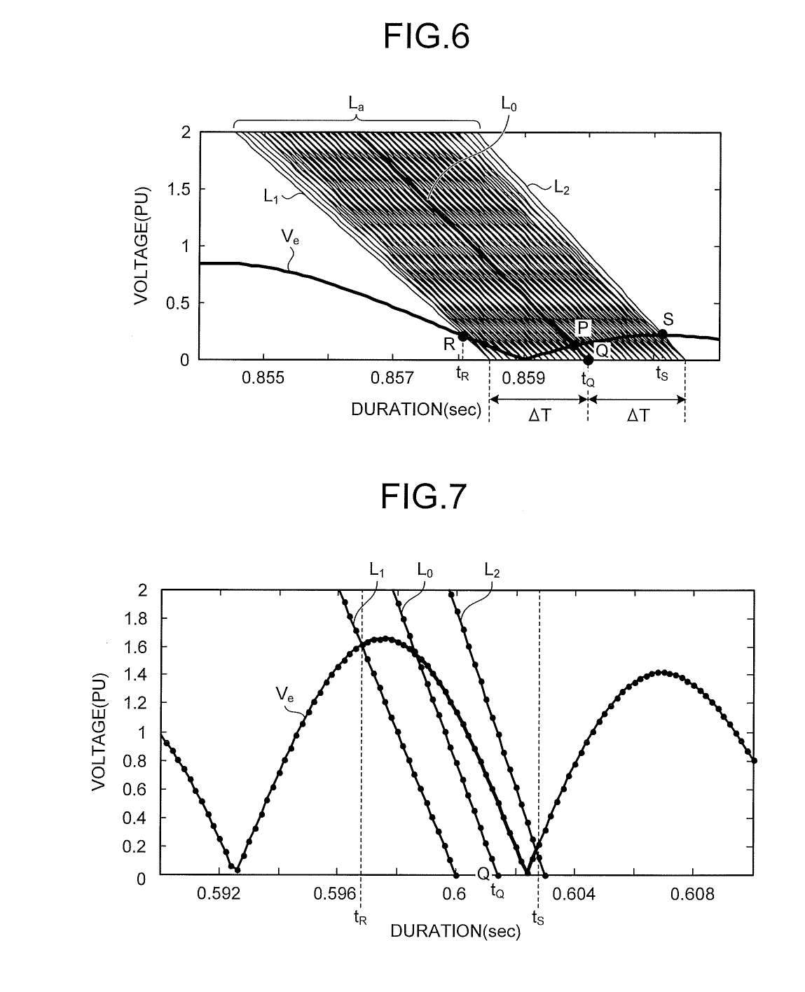

With respect to the dielectric strength change rate characteristic line L₀ having the rate of decrease of dielectric strength between electrodes at k with the closing time assumed to be at t_{Q} any arbitrary dielectric strength change rate characteristic line Lₐ that has the rate of decrease of dielectric strength between electrodes within a range from (k−Δk) to (k+Δk) and can exist between a dielectric strength change rate characteristic line L₁ having the closing time at (t_{Q}−ΔT) and the rate of decrease of dielectric strength between electrodes at (k−Δk) and a dielectric strength change rate characteristic line L₂ having the closing time at (t_{Q}+ΔT) and the rate of decrease of dielectric strength between electrodes at (k+Δk) determines the variation range of the electric turn-on time, with consideration given to the variations in the operation duration of the circuit breaker 2 and the variations in the gradient of the dielectric strength change rate characteristic line. This is illustrated specifically in FIG. 6.

FIG. 6 is a diagram for explaining a closing time range and an electric turn-on time range. Its horizontal axis and vertical axis are similar to those in FIG. 5. An absolute value waveform of estimate values of the interpolar voltage is designated with Vₑ, and other designations such as L₀ to L₂ are as described above. The range from a time (t_{Q}−ΔT) to a time (t_{Q}+ΔT) is hereinafter referred to as a “closing time range with respect to the closing time t_{Q}”. An actual electric turn-on time with respect to L₀ is in the range from a time t_{R} on the point of intersection R between Vₑ and L₁ to a time tₛ on the point of intersection S between Vₑ and L₂. The range from the times t_{R} to t_{R} is hereinafter referred to as an electric turn-on time range with respect to the closing time t_{Q}.

FIG. 7 is another diagram for explaining the closing time range and the electric turn-on time range. Its horizontal axis and vertical axis are similar to those in FIG. 6. The designations such as Vₑ and L₀ to L₂ are as described above. Note that Vₑ and L₀ to L₂ are plotted on discrete times. The illustration of lines Lₐ is omitted, except for L₀ to L₂.

On the basis of the above, after the interpolar voltage estimate value calculation unit 7a calculates the absolute value waveform of estimate values of the interpolar voltage Vₑ, the electric turn-on time range calculation unit 7b obtains, for each of times at which Vₑ is obtained (specifically, sampled discrete times), with respect to the dielectric strength change rate characteristic line L₀ having the rate of decrease of dielectric strength between electrodes at k with each of the times assumed to be the closing time t_{Q}, the dielectric strength change rate characteristic line L₁ having the rate of decrease of dielectric strength between electrodes at (k−Δk), which is smaller than that of L₀ by the rate of decrease of dielectric strength deviation width Δk, with the time (t_{Q}−ΔT), which is before the closing time t_{Q} by the closing time deviation width ΔT, assumed to be the closing time, and obtains the dielectric strength change rate characteristic line L₂ having the rate of decrease of dielectric strength between electrodes at (k+Δk), which is larger than that of L₀ by the rate of decrease of dielectric strength deviation width Δk, with the time (t_{Q}+ΔT), which is after the closing time t_{Q} by the closing time deviation width ΔT, assumed to be the closing time so as to obtain the time t_{R} on the point of intersection between Vₑ and L1 and the time tₛ on the point of intersection between Vₑ and L₂. The range from the times t_{R} to t_{S} is the electric turn-on time range.

The interpolar voltage maximum value calculation unit 7c further obtains the maximum value of Vₑ for each of the times at which Vₑ is obtained, within the electric turn-on time range calculated by the electric turn-on time range calculation unit 7b. That is, the maximum value of Vₑ is obtained for each of the times at which Vₑ is obtained.

The electric turn-on time range is a maximum variation range of the electric turn-on time determined by the closing time range and the range of the rate of decrease of dielectric strength. At the time (t_{Q}−ΔT), which is the lower limit of the closing time range, a time at the point of intersection between the dielectric strength change rate characteristic line L₁ having the minimum rate of decrease of dielectric strength between electrodes and Vₑ is obtained to minimize the lower limit of the electric turn-on time range, while at the time (t_{Q}+ΔT), which is the upper limit of the closing time range, a time at the point of intersection between the dielectric strength change rate characteristic line L₂ having the maximum rate of decrease of dielectric strength between electrodes and Vₑ is obtained to maximize the upper limit of the electric turn-on time range.

In the manner described above, with each of the times of Vₑ assumed to be the closing time t_{Q}, the maximum value of Vₑ within the electric turn-on time range with respect to the closing time t_{Q} can be obtained on the basis of the degree of variations in the operation duration of the circuit breaker 2 and the degree of variations in the rate of decrease of dielectric strength between electrodes. The maximum value of Vₑ within the electric turn-on time range calculated with respect to each of the times of Vₑ is hereinafter referred to as the “maximum value of the interpolar voltage” with respect to each of the times.

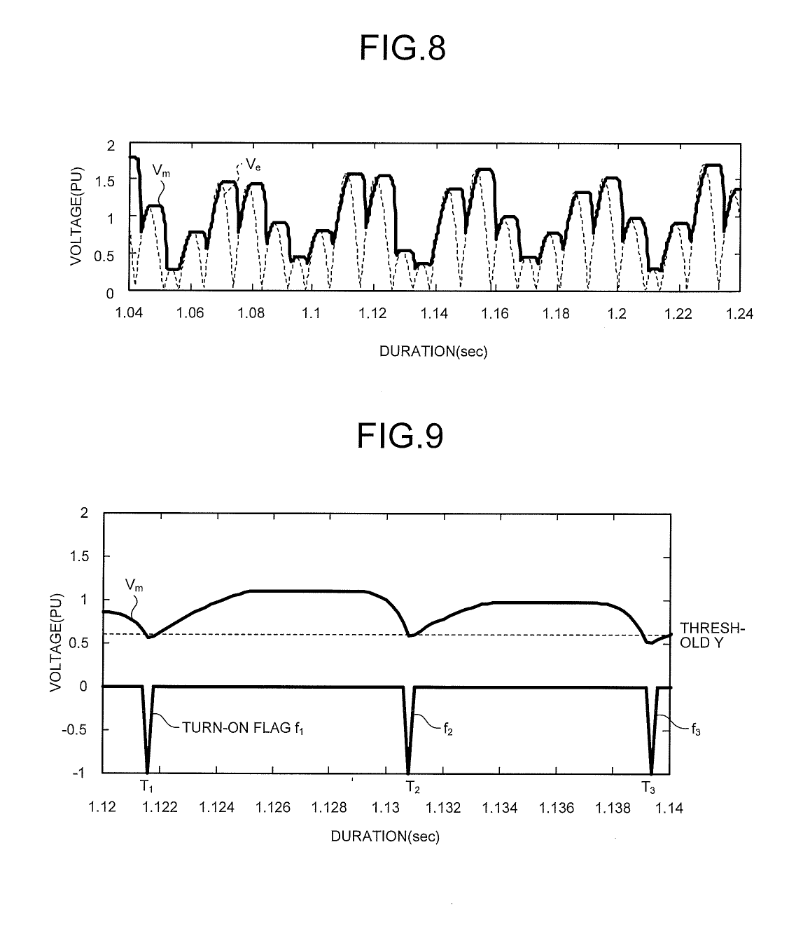

FIG. 8 is a diagram illustrating an example waveform of maximum values of the interpolar voltage. In FIG. 8, the absolute value waveform of estimate values of the interpolar voltage Vₑ and a waveform of maximum values of the interpolar voltage Vₘ are illustrated with the horizontal axis representing the duration (sec) and the vertical axis representing the voltage (PU). Here, the waveform of maximum values of the interpolar voltage Vₘ is a waveform that provides the maximum value of the interpolar voltage for each of the times at which Vₑ is defined.

After the interpolar voltage maximum value calculation unit 7c calculates the waveform of maximum values of the interpolar voltage Vₘ, the target closing time determination unit 7d sets the time at which the maximum value of the interpolar voltage is not more than the threshold Y and achieves the local minimum value as a target closing time. By setting a target closing time in this manner, the interpolar voltage at the time of turning on electrically does not exceed the maximum value of the interpolar voltage at the target closing time even with consideration given to the variations in the operation duration of the circuit breaker 2 and the variations in the rate of decrease of dielectric strength.

FIG. 9 is a diagram for explaining example of setting of a target closing time. In FIG. 9, the waveform of maximum values of the interpolar voltage Vₘ is illustrated with the horizontal axis representing the duration (sec) and the vertical axis representing the voltage (PU). The designation Y represents the threshold described above. In the illustrated example, three times, T₁ to T₃, are calculated as target closing times. That is, at each of the times of T₁ to T₃, the maximum value of the interpolar voltage is not more than the threshold Y and achieves the local minimum value where the differential coefficient of the waveform of maximum values of the interpolar voltage Vₘ is zero. In this diagram, turn-on flags f1 to f3 are also provided at the target closing times. A turn-on flag is given the value of, for example, −1 at a target closing time. With consideration given only to the phase in question and no consideration given to the other phases, any of T₁ to T₃ can be a target closing time.

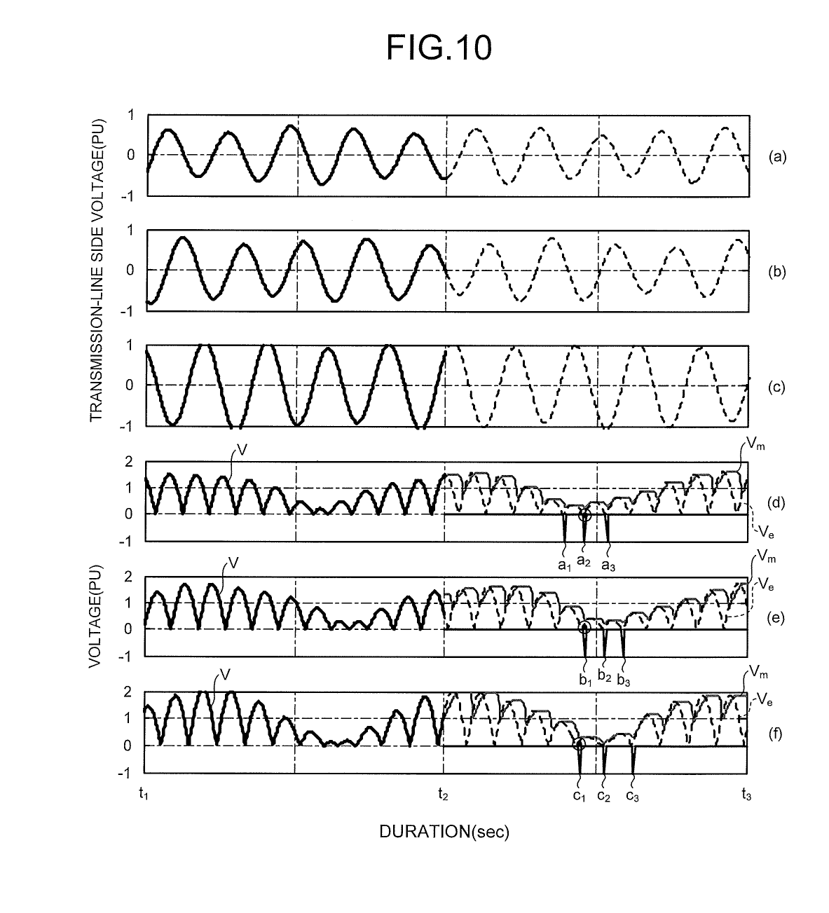

Regarding the three phases of circuit breaker 2 for, the times of their respective turn-on flags do not coincide with each other. This is illustrated specifically in FIG. 10. FIG. 10 is a diagram illustrating turn-on flags of each phase.

More specifically, FIG. 10(a) is a diagram illustrating the transmission-line side voltage waveform for a phase A. Its horizontal axis represents the duration (sec), and its vertical axis represents the transmission-line side voltage (PU). The present time is t₂. The part of the transmission-line side voltage waveform from the time t₁ to t₂ serves as an analysis waveform. FIG. 10(b) is a diagram illustrating the transmission-line side voltage waveform for a phase B. Its horizontal axis and vertical axis are similar to those in FIG. 10(a). The part of the transmission-line side voltage waveform from the time t₁ to t₂ serves as an analysis waveform. FIG. 10(c) is a diagram illustrating the transmission-line side voltage waveform for a phase C. Its horizontal axis and vertical axis are similar to those in FIG. 10(a). The part of the transmission-line side voltage waveform from the time t₁ to t₂ serves as an analysis waveform.

FIG. 10(d) is a diagram illustrating the absolute value waveform of the interpolar voltage V for the phase A, the absolute value waveform of estimate values of the interpolar voltage Vₑ for the phase A, and the waveform of maximum values of the interpolar voltage Vₘ for the phase A. Its horizontal axis represents the duration (sec), and its vertical axis represents the voltage (PU). The waveform V is illustrated only in the range from the time t₁ to t₂. The waveform Vₑ is estimated in the range from the time t₂ to t₃, and it is same for the waveform Vₘ. In this range, turn-on flags a₁ to a₃ are provided.

FIG. 10(e) is a diagram illustrating similarly the absolute value waveform of the interpolar voltage V for the phase B, the absolute value waveform of estimate values of the interpolar voltage Vₑ for the phase B, and the waveform of maximum values of the interpolar voltage Vₘ for the phase B. Its horizontal axis and vertical axis are similar to those in FIG. 10(d). The range in which the waveform V is illustrated and the range in which the waveforms Vₑ and Vₘ are estimated are similar to those is FIG. 10(d). Turn-on flags b₁ to b₃ are provided in the range from the time t₂ to t₃.

FIG. 10(f) is a diagram illustrating similarly the absolute value waveform of the interpolar voltage V for the phase C, the absolute value waveform of estimate values of the interpolar voltage Vₑ for the phase C, and the waveform of maximum values of the interpolar voltage Vₘ for the phase C. Its horizontal axis and vertical axis are similar to those in FIG. 10(d). The range in which the waveform V is illustrated and the range in which the waveforms Vₑ and Vₘ are estimated are similar to those in FIG. 10(d). Turn-on flags c₁ to c₃ are provided in the range from the time t₂ to t₃.

As illustrated in FIGS. 10(d) to (f), the times at which the turn-on flags a₁ to a₃ of the phase A are provided, the times at which the turn-on flags b₁ to b₃ of the phase B are provided, and the times at which the turn-on flags c₁ to c₃ of the phase C are provided are different from one another.

The circuit breaker 2 for three phases is connected at the three-phase AC power source 1 on the power source side and at the end of the three phase transmission line 3 on the transmission line side. Thus, if a target turn-on time is determined independently for each phase, the induced voltage of the phase turned on first causes the voltages of the other phases on the transmission line side to fluctuate and may thereby affect the accuracy of the transmission-line side voltage estimate values.

Hence, in the present embodiment, the target closing time determination unit 7d determines a target closing time for each phase such that all the target closing times for the three phases are included in a certain preset duration range.

For example, in FIGS. 10(d) to (f), the time of the turn-on flag a₂ of the phase A, the time of the turn-on flag b₁ of the phase B, and the time of the turn-on flag c₁ of the phase C are included in a certain preset duration range (not illustrated). Hence, the target turn-on time for the circuit breaker 2 of the phase A is the time of the turn-on flag a₂, the target turn-on time for the circuit breaker 2 of the phase B is the time of the turn-on flag b₁, and the target turn-on time for the circuit breaker 2 of the phase C is the time of the turn-on flag c₁. By determining the target closing times for the three phases in such a manner, an overvoltage and an overcurrent at the time of turning on the circuit breakers 2 of the other phases can be inhibited similarly to the phase in which flag is turned on first.

Alternatively, the target closing time determination unit 7d may determine a target closing time for each phase such that the total sum of the maximum values of the interpolar voltage for the three phases is minimum. That is, the target closing time determination unit 7 d determines that the time of each phase at which the total sum of the local minimum values of the maximum values of the interpolar voltage of the three phases, which are not more than the threshold Y, is minimum be the target closing time for each phase. In this case, an overvoltage and an overcurrent at the time of turning on the circuit breakers 2 of the other phases can also be inhibited similarly to the phase turned on first.

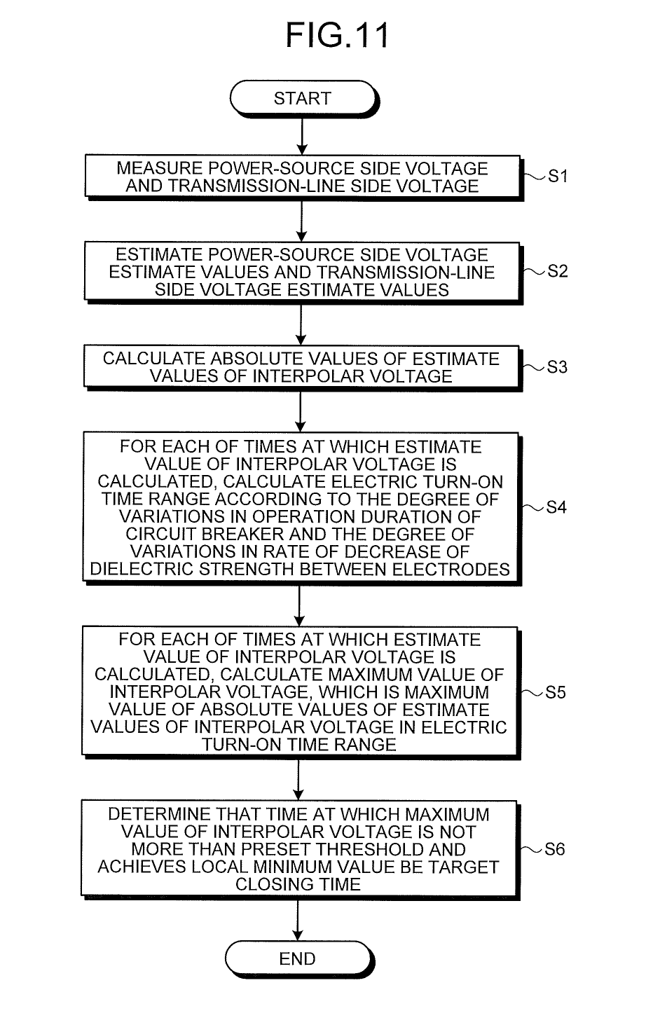

The operation in the present embodiment will now be described with reference to FIG. 11. FIG. 11 is a flowchart illustrating a closing control method according to the present embodiment.

The voltage measurement unit 5 measures the power-source side voltage and the transmission-line side voltage of the circuit breaker 2 after the opening of the circuit breaker 2 (S1).

The voltage estimation unit 6 then estimates power-source side voltage estimate values on and after the present time on the basis of measurement values of the power-source side voltage output from the voltage measurement unit 5 for, for example, a past certain duration and estimates transmission-line side voltage estimate values on and after the present time on the basis of measurement values of the transmission-line side voltage output from the voltage measurement unit 5 for, for example, a past certain duration (S2). Here, the voltage estimation unit 6 estimates a voltage estimate waveform as a multi-frequency composite waveform with consideration given to the attenuation of the amplitude as in the expression (1) described above.

The interpolar voltage estimate value calculation unit 7a then calculates an estimate value of the interpolar voltage, which is the difference between a power-source side voltage estimate value and a transmission-line side voltage estimate value output from the voltage estimation unit 6, and calculates the absolute value of the estimate value of the interpolar voltage (S3).

For each of times at which an estimate value of the interpolar voltage is calculated within a duration range, the electric turn-on time range calculation unit 7b then assumes that each of the times is a closing time and calculates an electric turn-on time range, which is a maximum variation range of the electric turn-on time of the circuit breaker 2, determined by the closing time range, which is a variation range of the closing time calculated according to the degree of variations in the operation (closing) duration of the circuit breaker 2, and by the range of the rate of decrease of dielectric strength, which is a variation range of the rate of decrease of dielectric strength calculated according to the degree of variations in the rate of decrease of dielectric strength between electrodes (S4).

Specifically, for each of the times (t_{Q}) at which an estimate value of the interpolar voltage is calculated within the duration range, the electric turn-on time range calculation unit 7b assumes that the minimum closing time (t_{Q}−ΔT), which is the lower limit of the closing time range, is the closing time, and calculates the minimum electric turn-on time (t_{R}), which is an electric turn-on time determined by the minimum rate of decrease of dielectric strength (k−Δk), i.e. the lower limit of the range of the rate of decrease of dielectric strength, and by the absolute values of the estimate values of the interpolar voltage Vₑ, and the electric turn-on time range calculation unit 7b also assumes that the maximum closing time (t_{Q}+ΔT), which is the upper limit of the closing time range, is the closing time, and calculates the maximum electric turn-on time (t_{S}), which is an electric turn-on time determined by the maximum rate of decrease of dielectric strength (k+Δk), i.e. the upper limit of the range of the rate of decrease of dielectric strength, and by the absolute values of the estimate values of the interpolar voltage Vₑ, and then obtains the electric turn-on time range as the range from the minimum electric turn-on time (t_{R}) to the maximum electric turn-on time (t_{S}) (see FIGS. 6 and 7).

The interpolar voltage maximum value calculation unit 7c then calculates the maximum value of the interpolar voltage, which is the maximum value of the absolute value of the estimate value of the interpolar voltage in the electric turn-on time range, for each of the times at which an estimate value of the interpolar voltage is calculated within the time range (S5).

The target closing time determination unit 7d then determines that the time at which the maximum value of the interpolar voltage is not more than the threshold Y and achieves the local minimum value be a target closing time (S6).

The target closing time determination unit 7d outputs the target closing time to the closing control unit 8. Generally, a plurality of target closing times are determined. The closing control unit 8 outputs a closing control signal at a time that is immediately after the input of a closing command, out of the times before the target closing times by the predicted closing time, in accordance with the closing command.

In FIG. 1, the closing duration prediction unit 11 outputs a predicted closing duration to the closing control unit 8, although it may output it to the target closing time calculation unit 7. In this case, after determining the target closing time, the target closing time calculation unit 7 calculates a time before the target closing time by the predicted closing time and outputs the calculated time to the closing control unit 8.

As described above, in the present embodiment, after the opening of the circuit breaker 2, a power-source side voltage estimate value and a transmission-line side voltage estimate value, and an estimate value of the interpolar voltage are estimated on the basis of measurement values of the power-source side voltage and the transmission-line side voltage; then, for each of times at which an estimate value of the interpolar voltage is calculated, the electric turn-on time range, which is a maximum possible variation range of the electric turn-on time of the circuit breaker 2, determined by the closing time range based on variations in the operation duration of the circuit breaker 2 with each of the times assumed to be the closing time and by the range of the rate of decrease of dielectric strength based on variations in the rate of decrease of dielectric strength between electrodes of the circuit breaker 2 is calculated; then, for each of the times at which an estimate value of the interpolar voltage is calculated, the maximum value of the interpolar voltage, which is the maximum value of the absolute value of the estimate value of the interpolar voltage in the electric turn-on time range, is calculated; and then, it is determined that the time at which the maximum value of the interpolar voltage is not more than the threshold Y and achieves the local minimum value be a target closing time.

As in the manner described above, after a transmission-line side voltage estimate value at the time of turning the circuit breaker 2 back on is obtained, the maximum value of the interpolar voltage is calculated for each of the times at which an estimate value of the interpolar voltage is defined, also in consideration of variations in the operation duration of the circuit breaker 2 and variations in the rate of decrease of dielectric strength between electrodes of the circuit breaker 2, and then it is determined that the time at which the maximum value of the interpolar voltage is not more than a threshold and achieves the local minimum value is to be a target closing time; thus, an overvoltage and an overcurrent can be sufficiently inhibited from occurring when the circuit breaker is turned back on.

As illustrated in FIG. 7, the electric turn-on time range is determined by the time (t_{R}) at the point of intersection between L₁ and Vₑ and the time (t_{S}) at the point of intersection between L₂ and Vₑ for each of the times (t_{Q}) at which an estimate value of the interpolar voltage is calculated within the time range. The electric turn-on time range can be obtained by obtaining substantially two points of intersection and accordingly the computation processing time is extremely short.

Additionally, in the present embodiment, the target closing time for each phase can be determined such that all the target closing times for the three phases are included in a certain preset duration range, or the target closing time for each phase can be determined such that the total sum of the maximum values of the interpolar voltage of the three phases is minimum. By determining the target closing times for the three phases in such a manner, an overvoltage and an overcurrent at the time of turning on the circuit breakers 2 for the other phases can be inhibited similarly to the phase turned on first.

Additionally, in the present embodiment, the waveform of the transmission-line side voltage estimate values is estimated as a multi-frequency composite waveform with waveform parameters of the amplitude, the frequency, the attenuation factor and the phase by using, for example, the method of least squares. Thus, an overvoltage and an overcurrent can be inhibited from occurring to a greater degree than that of the method described in Patent Literature 1 in which, on the assumption that the transmission-line side voltage does not attenuate after the current interruption, the timing to turn on a circuit breaker is calculated by using a measurement value of the transmission-line side voltage immediately after the current interruption. Note that, as described in a second embodiment, the transmission-line side voltage estimate value can be estimated by using a method other than the method of least squares.

### Second Embodiment

In the present embodiment, a method of estimating a voltage estimate value, especially a transmission-line side voltage estimate value after the opening of the circuit breaker 2 will be described. Since the configuration of a power switching control apparatus according to the present embodiment is identical with that of the first embodiment, its description will be omitted here.

The procedure to estimate a voltage waveform according to the present embodiment is as described below. The steps described below are mainly performed by the voltage estimation unit 6.
(a) A voltage waveform (analysis waveform) including n points from a waveform acquisition start time (t₁) to a waveform acquisition end time (t₂) is acquired (see FIG. 2).
(b) A residual matrix [B] and an eigenvalue λᵢ are calculated by a matrix pencil method.
(c) A voltage estimate value waveform y(t) in a duration t is generated on the basis of the residual matrix [B] and the eigenvalue λᵢ.

In the first embodiment, y(t) is assumed as on the right side of a following expression (2):

$$\begin{matrix}[ Expression 2 ] & \\ y ( t ) = {\sum }_{i = 1}^{M} {A}_{i} exp ( {σ}_{i} t ) cos ( 2 π {f}_{i} t + {φ}_{i} ) , & ( 2 )\end{matrix}$$

to determine the waveform parameters by using the method of least squares. In the present embodiment, the matrix pencil method, which is to be explained below, is used to estimate y(t). Details of the matrix pencil method are described in, for example, “Computational Methods for Electric Power Systems, Second Edition, Mariesa L. Crow, CRC Press.”

An outline of the matrix pencil method will now be described. With a measurement value y(k) of the transmission-line side voltage or the power-source side voltage expressed in an expression (3) below, the matrix pencil method provides a method to obtain the eigenvalue λᵢ and the residual matrix [B].

$$\begin{matrix}[ Expression 3 ] & \\ y ( k ) = {\sum }_{i = 1}^{M} {B}_{i} {z}_{i}^{k} = {\sum }_{i = 1}^{M} {B}_{i} exp \{ ( {λ}_{i} Δ t ) k \} & ( 3 )\end{matrix}$$

Here, M represents the number of modes, Δt represents a sampling time period, and k represents the sampling number (=0, 1, . . . , n−1). Additionally, Bᵢ is an initial value and is a diagonal component of the residual matrix [B].

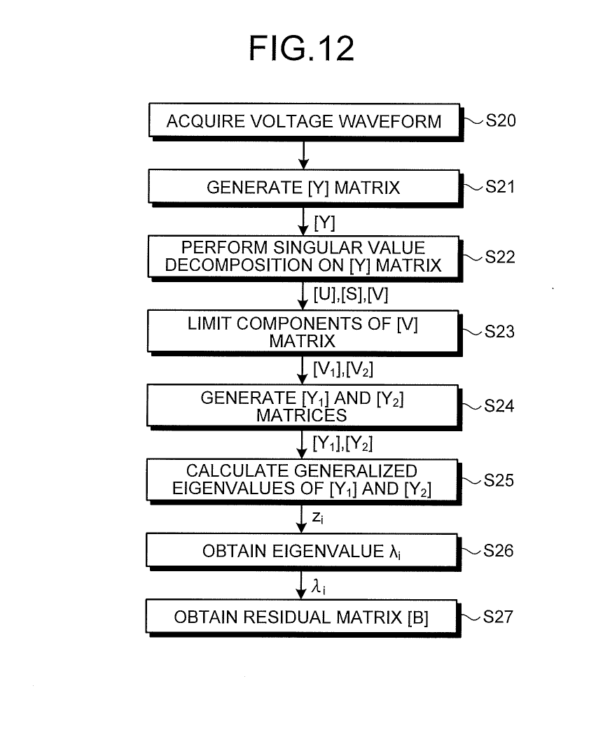

FIG. 12 is a flowchart illustrating a calculation process of the eigenvalue 80 ᵢ and the residual matrix [B]. The voltage estimation unit 6 acquires the voltage waveform y(k) (k=0, 1, . . . , n−1) (S20) and generates a matrix [Y] below from the acquired voltage waveform y(k) (S21).

$$\begin{matrix}[ Expression 4 ] & \\ [ Y ] = [ \begin{matrix}y ( 0 ) & y ( 1 ) & … & y ( L ) \\ y ( 1 ) & y ( 2 ) & … & y ( L + 1 ) \\ ⋮ & ⋮ & ⋱ & ⋮ \\ y ( N - L ) & y ( N - L + 1 ) & … & y ( N )\end{matrix} ] & ( 4 )\end{matrix}$$

Here, N=n−1, and L is a pencil parameter. The pencil parameter may be, for example, L=N/2.

The voltage estimation unit 6 then performs singular value decomposition on the matrix [Y] as [Y]=[U][S][V]^{T} to obtain matrices [U], [S], and [V] (S22). Here, [S] is a matrix having a singular value as a diagonal component. Additionally, [U] and [V] are real numeric unitary matrices containing eigenvectors of [Y][Y]^{T} and [Y]^{T}[Y]. Also, T represents transposition. The matrices [U], [S], and [V] are expressed with components as below.

$$\begin{matrix}[ Expression 5 ] & \\ [ U ] = [ \begin{matrix}{u}_{1 , 1} & {u}_{1 , 2} & … & {u}_{1 , N - L + 1} \\ {u}_{2 , 1} & {u}_{2 , 2} & … & {u}_{2 , N - L + 2} \\ ⋮ & ⋮ & ⋱ & ⋮ \\ {u}_{N - L + 1 , 1} & {u}_{N - L + 1 , 2} & … & {u}_{N - L + 1 , N - L + 1}\end{matrix} ] & ( 5 ) \\ [ Expression 6 ] & \\ [ S ] = [ \begin{matrix}{s}_{1 , 1} & {s}_{1 , 2} & … & {s}_{1 , L + 1} \\ {s}_{2 , 1} & {s}_{2 , 2} & … & {s}_{2 , L + 2} \\ ⋮ & ⋮ & ⋱ & ⋮ \\ {s}_{N - L + 1 , 1} & {s}_{N - L + 1 , 2} & … & {s}_{N - L + 1 , L + 1}\end{matrix} ] & ( 6 ) \\ [ Expression 7 ] & \\ [ V ] = [ \begin{matrix}{v}_{1 , 1} & {v}_{1 , 2} & … & {v}_{1 , L + 1} \\ {v}_{2 , 1} & {v}_{2 , 2} & … & {v}_{2 , L + 1} \\ ⋮ & ⋮ & ⋱ & ⋮ \\ {v}_{L + 1 , 1} & {v}_{L + 1 , 2} & … & {v}_{L + 1 , L + 1}\end{matrix} ] & ( 7 )\end{matrix}$$

The voltage estimation unit 6 then extracts part of matrix elements from [V] obtained by the singular value decomposition to obtain [V₁] and [V₂] (S23). Specifically, the voltage estimation unit 6 employs M pieces of singular values in the descending order on the basis of a predetermined parameter M to limit the number of effective components.

$$\begin{matrix}[ Expression 8 ] & \\ [ {V}_{1} ] = [ \begin{matrix}{v}_{1 , 1} & {v}_{1 , 2} & … & {v}_{1 , M} \\ {v}_{2 , 1} & {v}_{2 , 2} & … & {v}_{2 , M} \\ ⋮ & ⋮ & ⋱ & ⋮ \\ {v}_{L , 1} & {v}_{L , 2} & … & {v}_{L , M}\end{matrix} ] & ( 8 ) \\ [ Expression 9 ] & \\ [ {V}_{2} ] = [ \begin{matrix}{v}_{2 , 1} & {v}_{2 , 2} & … & {v}_{2 , M} \\ {v}_{3 , 1} & {v}_{3 , 2} & … & {v}_{3 , M} \\ ⋮ & ⋮ & ⋱ & ⋮ \\ {v}_{L + 1 , 1} & {v}_{L + 1 , 2} & … & {v}_{L + 1 , M}\end{matrix} ] & ( 9 )\end{matrix}$$

The voltage estimation unit 6 then generates matrices [Y₁] and [Y₂] from [V₁] and [V₂] (S24). Here, they are expressed as follows:

[Y₁]=[V₁]^{T}×[V₁]

[Y₂]=[V₂]^{T}×[V₁].

The voltage estimation unit 6 then solves an expression (10) below to calculate a vector [z] including generalized eigenvalues of the matrices [Y₁] and [Y₂] (S25).

[Expression 10]

[Y₂]−λ[Y₁]=[Z₁][B]{[Z₀]−λ[I]}[Z₂] (10)

Note that [B] represents a residual matrix, [I] represents a unit matrix of M×M, and [Z₀] to [Z₂] are as expressed below.

$$\begin{matrix}[ Expression 11 ] & \\ [ {Z}_{0} ] = diag [ {z}_{1} , {z}_{2} , … {z}_{M} ] & ( 11 ) \\ [ Expression 12 ] & \\ [ {Z}_{1} ] = [ \begin{matrix}1 & 1 & … & 1 \\ {z}_{1} & {z}_{2} & … & {z}_{M} \\ ⋮ & ⋮ & & ⋮ \\ {z}_{1}^{( N - L - 1 )} & {z}_{2}^{( N - L - 1 )} & … & {z}_{M}^{( N - L - 1 )}\end{matrix} ] & ( 12 ) \\ [ Expression 13 ] & \\ [ {Z}_{2} ] = [ \begin{matrix}1 & {z}_{1} & … & {z}_{1}^{L - 1} \\ 1 & {z}_{2} & … & {z}_{2}^{L - 1} \\ ⋮ & ⋮ & & ⋮ \\ 1 & {z}_{M} & … & {z}_{M}^{L - 1}\end{matrix} ] & ( 13 )\end{matrix}$$

The voltage estimation unit 6 then obtains an eigenvalue vector [λ] from [z]=(z₁, z₂, . . . , z_{M})^{T} (S26).

$$\begin{matrix}[ Expression 14 ] & \\ {λ}_{i} = \frac{ln ( {z}_{i} )}{Δ t} & ( 14 )\end{matrix}$$

The voltage estimation unit 6 also obtains the residual matrix [B] from the relationship below (S27).

$$\begin{matrix}[ Expression 15 ] & \\ [ \begin{matrix}{z}_{1}^{0} & {z}_{2}^{0} & … & {z}_{M}^{0} \\ {z}_{1}^{1} & {z}_{2}^{1} & … & {z}_{M}^{1} \\ ⋮ & ⋮ & & ⋮ \\ {z}_{1}^{N} & {z}_{2}^{N} & … & {z}_{M}^{N}\end{matrix} ] [ \begin{matrix}{B}_{1} \\ {B}_{2} \\ ⋮ \\ {B}_{M}\end{matrix} ] = [ \begin{matrix}y ( 0 ) \\ y ( 1 ) \\ ⋮ \\ y ( N )\end{matrix} ] & ( 15 )\end{matrix}$$

The voltage estimation unit 6 further calculates the voltage estimate waveform y(t) at any arbitrary time t by substitution of the eigenvalues λᵢ and Bᵢ obtained through the expression (14) and the expression (15) into an expression (16) below.

$$\begin{matrix}[ Expression 16 ] & \\ y ( t ) = {\sum }_{i = 1}^{M} {B}_{i} {e}^{{λ}_{i} t} & ( 16 )\end{matrix}$$

In this manner, the matrix pencil method performs the computation on the basis of matrix calculation and by extracting a component of large amplitude (singular value), thereby reducing the computation processing time and improving the computational precision.

As described above, the present embodiment estimates voltage estimate values as a multi-frequency composite waveform by using the matrix pencil method and thus is capable of reducing the computation processing time, improving the computational precision, and inhibiting an overvoltage and an overcurrent from occurring when the circuit breaker is turned back on to a further greater degree.

### INDUSTRIAL APPLICABILITY

As described above, the present invention is useful as a power switching control apparatus and a closing control method thereof.

### REFERENCE SIGNS LIST

1 power source, 2 circuit breaker, 3 transmission line, 4 power switching control apparatus, 5 voltage measurement unit, 6 voltage estimation unit, 7 target closing time calculation unit, 7 an interpolar voltage estimate value calculation unit, 7b electric turn-on time range calculation unit, 7c interpolar voltage maximum value calculation unit, 7d target closing time determination unit, 8 closing control unit, 9 auxiliary switch, 10 closing duration measurement unit, 11 closing duration prediction unit, 12a environmental temperature measurement unit, 12 operating environmental condition measurement unit, 12b control voltage measurement unit, 12c operating pressure measurement unit.

1. A power switching control apparatus, comprising:
a voltage measurement unit to measure a power-source side voltage and a transmission-line side voltage of a circuit breaker;
a voltage estimation unit to estimate a power-source side voltage estimate value on and after a present time according to a measurement value of the power-source side voltage and to estimate a transmission-line side voltage estimate value on and after the present time according to a measurement value of the transmission-line side voltage;
a target closing time calculation unit to calculate a target closing time of the circuit breaker according to the power-source side voltage estimate value and the transmission-line side voltage estimate value; and
a closing control unit to output a closing control signal to the circuit breaker according to the target closing time, wherein
the target closing time calculation unit comprises:
an interpolar voltage estimate value calculation unit to calculate an interpolar voltage estimate value by using the power-source side voltage estimate value and the transmission-line side voltage estimate value;
an electric turn-on time range calculation unit to assume, for each of times at which the interpolar voltage estimate value is calculated, that each of the times is a closing time and to calculate an electric turn-on time range, which is a maximum variation range of an electric turn-on time of the circuit breaker, according to the degree of variations in a closing duration of the circuit breaker and the degree of variations in a rate of decrease of dielectric strength between electrodes of the circuit breaker;
an interpolar voltage maximum value calculation unit to calculate, for each of the times, a maximum value of interpolar voltage, which is a maximum value of an absolute value of the interpolar voltage estimate value in the electric turn-on time range; and
a target closing time determination unit to determine that a time at which the maximum value of the interpolar voltage is not more than a threshold and achieves a local minimum value be the target closing time.

2. The power switching control apparatus according to claim 1, wherein the electric turn-on time range calculation unit assumes, for each of the times at which the interpolar voltage estimate value is calculated, that each of the times is a closing time, obtains a closing time range, which is a variation range of the closing time, according to the degree of variations in the closing duration of the circuit breaker, obtains a range of the rate of decrease of dielectric strength, which is a variation range of the rate of decrease of dielectric strength, according to the degree of variations in the rate of decrease of dielectric strength between electrodes, assumes that a minimum closing time, which is a lower limit of the closing time range, is a closing time, calculates a minimum electric turn-on time, which is an electric turn-on time determined by a minimum rate of decrease of dielectric strength, i.e. a lower limit of the range of the rate of decrease of dielectric strength and by the absolute value of the interpolar voltage estimate value, assumes that a maximum closing time, which is an upper limit of the closing time range, is a closing time, calculates a maximum electric turn-on time, which is an electric turn-on time determined by a maximum rate of decrease of dielectric strength, i.e. an upper limit of the range of the rate of decrease of dielectric strength and by the absolute value of the interpolar voltage estimate value, so as to obtain the electric turn-on time range as a range from the minimum electric turn-on time to the maximum electric turn-on time.

3. The power switching control apparatus according to claim 1, wherein the target closing time determination unit determines a target closing time for each phase such that all target closing times for three phases are included in a certain preset duration range.

4. The power switching control apparatus according to claim 1, wherein the target closing time determination unit determines a target closing time for each phase such that a total sum of local minimum values of maximum values of the interpolar voltage for three phases is minimum.

5. The power switching control apparatus according to claim 1, wherein the voltage estimation unit estimates a waveform of the transmission-line side voltage estimate value as a multi-frequency composite waveform by using a method of least squares.

6. The power switching control apparatus according to claim 1, wherein the voltage estimation unit estimates a waveform of the transmission-line side voltage estimate value as a multi-frequency composite waveform by using a matrix pencil method.

7. A closing control method of a power switching control apparatus, the apparatus comprising: a voltage measurement unit to measure a power-source side voltage and a transmission-line side voltage of a circuit breaker; a voltage estimation unit to estimate a power-source side voltage estimate value on and after a present time according to a measurement value of the power-source side voltage and to estimate a transmission-line side voltage estimate value on and after the present time according to a measurement value of the transmission-line side voltage; a target closing time calculation unit to calculate a target closing time of the circuit breaker according to the power-source side voltage estimate value and the transmission-line side voltage estimate value; and a closing control unit to output a closing control signal to the circuit breaker according to the target closing time, the method comprising:
the target closing time calculation unit calculating an interpolar voltage estimate value by using the power-source side voltage estimate value and the transmission-line side voltage estimate value;
the target closing time calculation unit assuming, for each of times at which the estimate value is calculated, that each of the times is a closing time and calculates an electric turn-on time range, which is a maximum variation range of an electric turn-on time of the circuit breaker, according to the degree of variations in a closing duration of the circuit breaker and the degree of variations in a rate of decrease of dielectric strength between electrodes of the circuit breaker;
the target closing time calculation unit calculating, for each of the times, a maximum value of interpolar voltage, which is a maximum value of an absolute value of the interpolar voltage estimate value in the electric turn-on time range; and
the target closing time calculation unit determining a time at which the maximum value of the interpolar voltage is not more than a threshold and achieves a local minimum value be the target closing time.
